(19) United States
(12) Patent Application Publication
(10) Pub. No.: US 2022/0318448 A1
(43) Pub. Date: Oct. 6, 2022

(54) CABLE ROUTE DESIGN METHOD

(71) Applicant: NIPPON TELEGRAPH AND TELEPHONE CORPORATION, Tokyo (JP)

(72) Inventors: Kuniaki TERAKAWA, Musashino-shi, Tokyo (JP); Tomohiro KAWANO, Musashino-shi, Tokyo (JP); Tatsuya FUJIMOTO, Musashino-shi, Tokyo (JP); Kazunori KATAYAMA, Musashino-shi, Tokyo (JP); Tomomi NAGAO, Musashino-shi, Tokyo (JP)

(73) Assignee: NIPPON TELEGRAPH AND TELEPHONE CORPORATION, Tokyo (JP)

(21) Appl. No.: 17/639,310

(22) PCT Filed: Sep. 3, 2019
(86) PCT No.: PCT/JP2019/034550

§ 371 Date: Feb. 28, 2022

(51) Int. Cl. G06F 30/18

(52) U.S. Cl. CPC G06F 30/18; G06F 2113/02

(57) ABSTRACT

An object of the present invention is to provide a cable route design method that makes it possible to select a route for routing a communication cable in consideration of an influence of an air-conditioning airflow under a double floor. According to the present cable route design method, cables are routed such that an air-conditioning space under a double floor becomes as uniform as possible, a floor is modeled in a mesh structure, and one of cable routing patterns is applied to each of meshes and an air-conditioning airflow is calculated by a finite volume method, thereby indexing (an evaluation value) an air-conditioning efficiency. This enables comparison between a plurality of cable routing ideas, making it possible to find an optimal routing route.

### TECHNICAL FIELD

The present disclosure relates to a design algorithm for automatically designing a route for routing a cable under a double floor of a data center (DC) or a communication building.

### BACKGROUND ART

In a case where a DC or a communication building has a double floor, communication cables are laid under the double floor from an aggregation rack within the floor to racks on which target servers are mounted or removed from thereunder in accordance with a change in the number of servers (for example, see Patent Literature 1 and Non-Patent Literature 1).

### CITATION LIST

### Patent Literature

Patent Literature 1: Japanese Patent Laid-Open No. 2003-224657

### Non-Patent Literature

Non-Patent Literature 1: Tomohiro Kawano, Tatsuya Fujimoto, Kuniaki Terakawa, Kazunori Katayama, Tomomi Nagao and Atsushi Sakurai, “Study of Novel Data Center Cabling Method for Low Cost Operation and High Security,” IWCS China 2019, 5-2, 2019.

### SUMMARY OF THE INVENTION

### Technical Problem

However, there are only a few cases where communication cables are laid with a routing rule clearly established. For example, in many cases, the shortest route from an aggregation rack (a start point) to the target racks (end points) or a route easy to lay the cables is selected at the discretion of a builder. In particular, there has been so far no case where a route for routing communication cables is selected in consideration of an influence of an air-conditioning airflow under a double floor.

Even in a case where a route is systematically selected in anticipation of future demand, the communication cables fail to be evenly distributed in a plane under the double floor unless the route is selected in consideration of the influence of the air-conditioning airflow under the double floor. This results in a non-uniform distribution with, for example, local concentration or tangle of the communication cables. A non-uniform distribution of the communication cables under a double floor causes an air-conditioning airflow for cooling the servers to inefficiently pass through a space under the double floor. A trouble such as a device failure is likely to occur unless the servers are cooled. To prevent such a trouble, for example, a power of the air-conditioning is increased, thereby forcefully circulating the air-conditioning under the double floor to cool the servers. Such an inefficient air-conditioning operation is attributed to a failure to provide an optical cable routing design in consideration of an air-conditioning efficiency due to absence of an index quantitively indicating a relationship between cable laying distribution and air-conditioning efficiency.

Once installed, an air-conditioning device and communication cables are difficult to re-install. Accordingly, the installed equipment usually continues to be used even if the air-conditioning efficiency is poor, which generates unnecessary costs for operation of the building. In other words, it has not been possible to know in advance a route for routing communication cables that enables minimizing a total cost now and in the future, making it difficult to reduce costs for operation of a DC or a communication building.

Accordingly, in order to solve the above-described problem, an object of the present invention is to provide a cable route design method that makes it possible to select a route for routing a communication cable in consideration of an influence of an air-conditioning airflow under a double floor.

### Means for Solving the Problem

To achieve the above-described object, in a cable route design method according to the present invention, a space under a double floor is divided into meshes, a heat map is formed on the basis of a dimension of an air-conditioning space with a group volume occupied by a communication cable eliminated per mesh, and an air-conditioning airflow is simulated.

Specifically, a cable route design method according to the present invention is intended to route, within one floor where there are one or a plurality of start points and a plurality of end points, a plurality of cables connecting respective pairs of the start point and the end points, the cable route design method including:

in a case where the floor has a double floor structure and the cables are to be routed in an underfloor space for air-conditioning,

dividing the floor into two-dimensional meshes;

creating a cable routing idea for routing within the floor by allocating one of a plurality of preset cable installation patterns to each of the meshes in accordance with a predetermined rule;

allocating an area ratio of a ventilation opening formed in a floor surface of the floor for each of the meshes to each of the meshes of the cable routing idea;

calculating, for each of the meshes, a value indicating a dimension of a space for air-conditioning based on a volume of the underfloor space and a group volume of the cables;

adding an air-conditioning airflow to a model of the underfloor space in which the meshes are heat-mapped based on the value regarding the space for air-conditioning and performing thermo-fluid analysis of the airflow in the underfloor space until the airflow flowing out of the underfloor space through the ventilation opening decreases to a predetermined level;

acquiring, for each of the meshes, a flow speed of the decreased airflow flowing out of the underfloor space; and

summing the flow speeds in all the meshes as an evaluation value of the cable routing idea, in which

the predetermined rule includes:

(1) preventing the cables from intersecting as much as possible and, in a case where the cables inevitably intersect, equalizing a position of one of the meshes where the cables intersect within the floor; and
(2) shortening a total distance of the routed cables as much as possible.

In the present cable route design method, the cables are routed such that the air-conditioning space under the double floor becomes as uniform as possible and the air-conditioning efficiency is indexed (the evaluation value) by modeling the floor in a mesh structure, applying one of the cable routing patterns to each of meshes, and calculating the air-conditioning airflow by a finite volume method. This makes it possible to compare a plurality of cable routing ideas and find an optimal routing route.

Therefore, the present invention makes it possible to provide a cable route design method enabling selecting a route for routing a communication cable in consideration of an influence of an air-conditioning airflow under a double floor.

For example, among a plurality of the cable routing ideas, the cable routing idea the evaluation value of which is highest can be selected as an optimal idea.

It is preferable that the flow speeds be multiplied by respective weight coefficients for the meshes and the flow speeds multiplied by the respective weight coefficients be summed as the evaluation value.

For example, the value indicating the dimension of the space for air-conditioning is a height of the space for air-conditioning calculated by subtracting the group volume of the cables from the volume of the underfloor space.

In a specific example, the cables are single-conductor optical cables, the start point is an aggregation point where the plurality of single-conductor optical cables are aggregated, and the end points are each a location where a rack on which a communication apparatus is to be mounted is installed.

Alternatively, in another specific example, the cables are multi-conductor optical cables, the start point is an aggregation point where the plurality of multi-conductor optical cables are aggregated, and with an assumption that a plurality of racks on which communication apparatuses are to be mounted are considered as one group, the end points are sub-aggregation points disposed on a one-by-one basis at groups each including a plurality of racks on which communication apparatuses are to be mounted. In this case, the number of conductors of the multi-conductor optical cables to be selected is a nearest number of conductors larger than a necessary number of conductors based on future communication demand forecasting.

It should be noted that the above-described inventions may be combined as long as it is possible.

### Effect of the Invention

The present invention makes it possible to provide a cable route design method enabling selecting a route for routing a communication cable in consideration of an influence of an air-conditioning airflow under a double floor.

### BRIEF DESCRIPTION OF DRAWINGS

FIG. 1 is a flowchart illustrating a cable route design method according to the present invention.

FIG. 2 illustrates a process for creating a cable routing idea in the cable route design method according to the present invention.

FIG. 3 illustrates a process for creating a cable routing idea in the cable route design method according to the present invention.

FIG. 4 is a list of cable installation patterns in the cable route design method according to the present invention.

FIG. 5 is a list of panel opening ratios of a double floor in the cable route design method according to the present invention.

FIG. 6 illustrates a process for analyzing an airflow in the cable route design method of the present invention.

FIG. 7 illustrates a process for evaluating an air-conditioning efficiency in the cable route design method of the present invention.

FIG. 8 is a flowchart illustrating the cable route design method according to the present invention.

FIG. 9 illustrates a calculator that performs the cable route design method according to the present invention.

### DESCRIPTION OF EMBODIMENT

Description will be made on an embodiment of the present invention with reference to the attached drawings. The embodiment described below is an example of implementation of the present invention and the present invention is not limited to the following embodiment. It should be noted that components with reference signs that are the same herein and in the drawings are the same as each other.

### (Overview)

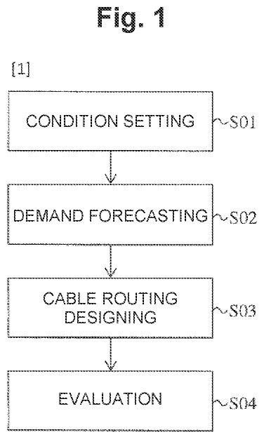

FIG. 1 is a flowchart illustrating a method of selecting a route for laying a communication cable in a communication building or a data center and that enables minimizing a total cost. It should be noted that the communication cable is exemplified by an optical cable in the present embodiment but a metal cable for electric communication is also acceptable.

Condition setting (Step S01) includes acquiring information regarding a building, a floor configuration, a cable, an air conditioner, a rack, devices, and other existing equipment/devices and setting various conditions necessary for designing.

Demand forecasting (Step S02) includes allocating a final necessary number of optical cables (necessary number of conductors) to each rack on the basis of a building operation cycle plan a device renewal plan, a service deployment plan, and other future plans. In a case where the future plans are unknown, a preset necessary number of conductors is allocated.

Cable routing designing (Step S03) includes creating a plurality of route ideas (routing ideas) for the optical cable within a floor in consideration of various conditions for each building.

Evaluation (Step S04) includes calculating, for each of the plurality of routing ideas, costs (an electric power cost for air-conditioning, a cable work cost), a man-hour of the work, and a lead time to opening and performing cost conversion to the same index, thereby determining one of the routing ideas that enables minimizing the total cost.

### Embodiment

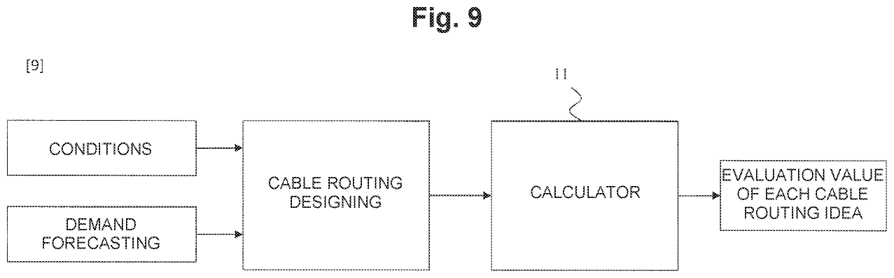

FIG. 9 illustrates a calculator 11 that evaluates a cable route. The cable route design method of the present embodiment includes, in Step S04 in FIG. 1, calculating an influence on air-conditioning for each of the plurality of routing ideas with use of the calculator 11 and evaluating the electric power cost for air-conditioning by comparison.

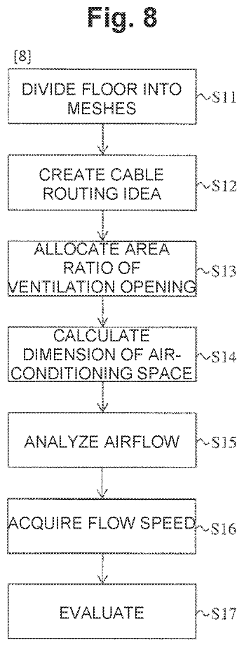

FIG. 8 is a flowchart illustrating the present cable route design method. The present cable route design method is intended to route, within one floor where there are one or a plurality of start points P and a plurality of end points G, a plurality of cables connecting respective pairs of the start point P and the end points G, the cable route design method including:

in a case where the floor has a double floor structure and the cables are to be routed in an underfloor space for air-conditioning,

dividing the floor into two-dimensional meshes (Step S11);

creating a cable routing idea for routing the cables within the floor by allocating one of a plurality of preset cable installation patterns to each of the meshes in accordance with a predetermined rule (Step S12);

allocating an area ratio of a ventilation opening formed in a floor surface of the floor for each of the meshes to each of the meshes of the cable routing idea (Step S13);

calculating, for each of the meshes, a value indicating a dimension of a space for air-conditioning based on a volume of the underfloor space and a group volume of the cables (Step S14);

adding an air-conditioning airflow to a model of the underfloor space in which the meshes are heat-mapped based on the value regarding the space for air-conditioning and performing thermo-fluid analysis of the airflow in the underfloor space until the airflow flowing out of the underfloor space through the ventilation opening decreases to a predetermined level (Step S15);

acquiring, for each of the meshes, a flow speed of the decreased airflow flowing out of the underfloor space (Step S16); and

summing the flow speeds in all the meshes as an evaluation value of the cable routing idea (Step S17), in which

the predetermined rule includes:

(1) preventing the cables from intersecting as much as possible and, in a case where the cables inevitably intersect, equalizing a position of one of the meshes where the cables intersect within the floor; and
(2) shortening a total distance of the routed cables as much as possible.

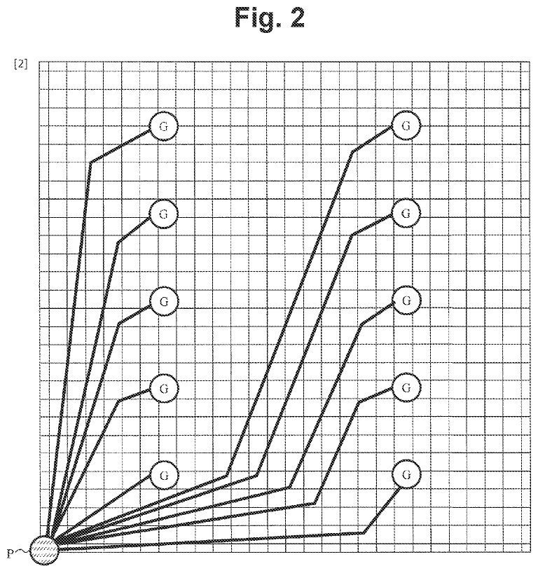

Referring to FIG. 2, description will be made on a case where the cables are multi-conductor optical cables, the start point P is an aggregation point where the plurality of multi-conductor optical cables are aggregated, and the end points G are sub-aggregation points disposed on a one-by-one basis at groups each including a plurality of racks on which communication apparatuses are to be mounted. In other words, FIG. 2 illustrates a process for creating a cable routing idea for multi-conductor optical cables to be routed under a double floor (Steps S11 to S12).

First, a plan view of a communication machine room (a server room) in a DC/communication building is divided into meshes (Step S11). The communication machine room usually has a double floor structure and a double floor (a double floor panel) is supported by a plurality of columns. With the assumption that a section corresponding to a minimum unit delimited in a square by four of columns is defined as one mesh, the entire communication machine room is divided in units of meshes.

Next, a necessary number of conductors of the optical cables is set per unit of rack from a final demanded number set by demand forecasting in Step S02. In a case where the final demanded number is unknown, a number based on experience of an operator may be set.

Subsequently, a plurality of neighboring racks are set as one group and one sub-aggregation point for the optical cables is set per unit of group. For example, two rows of five racks arranged side by side are set as one group. The sub-aggregation point, which has a cross-connection function, is equipment enabling conductor switching. An installation location of the sub-aggregation point is set near the racks in the group so that the optical cables can be distributed among the racks in the group. The installation location may be defined either under the double floor or on an upper side of the double floor. The necessary number of conductors for each group is obtained by integrating the respective necessary numbers of conductors for the racks and set as a necessary number of conductors for the sub-aggregation point.

Next, a plurality of route ideas (cable routing ideas) for routing the optical cables with the necessary number of conductors within a floor of the communication machine room are set with the assumption that the aggregation point (either one aggregation point or a plurality of aggregation points are acceptable), at which the optical cables all over the floor are aggregated, is defined as the start point and the sub-aggregation points are defined as the end points (Step S12). The routes are to be set in accordance with the following three rules.

(A) “The number of conductors of the optical cables to be selected should be the nearest number of conductors larger than the necessary number of conductors.”

Possible numbers of conductors of optical cables are discrete (for example, 4, 8, 16, . . . ). Accordingly, in a case where there is no number of conductors that is the same as the necessary number of conductors, optical cables with the nearest larger number of conductors (for example, the number of conductors of 16 for the necessary number of conductors of 12) should be used. A thickness of optical cables increases with an increase in the number of conductors, so that the optical cables are installed under the double floor with the space for air-conditioning reduced.

(B) “The optical cables should be prevented from being stacked as much as possible. If inevitably stacked, the optical cables should be flattened as much as possible by equalization so as not to be only partially stacked.”

The optical cables are arranged side by side, thereby preventing “stacking.” In this regard, “stacking” includes intersection of the optical cables. “Equalization” means dispersing, in order to prevent concentration of meshes in which stacking occurs in the entire floor, such meshes all over the floor.

(C) “A distance of a routing route should be as short as possible.”

It should be noted that in a case where Rules B and C compete against each other, Rule B has a priority.

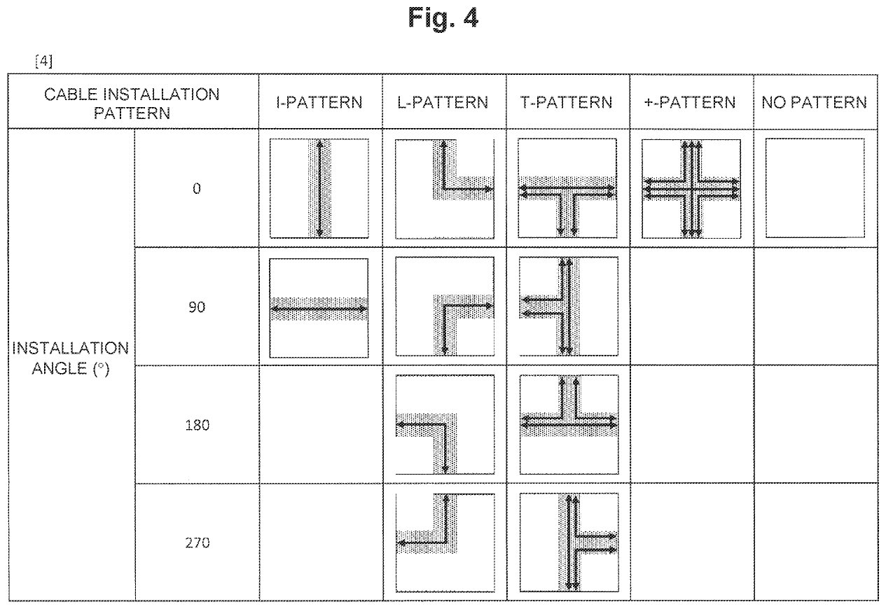

It should be noted that in making a cable routing idea, one of 12 routing patterns in FIG. 4 is allocated to each of the meshes.

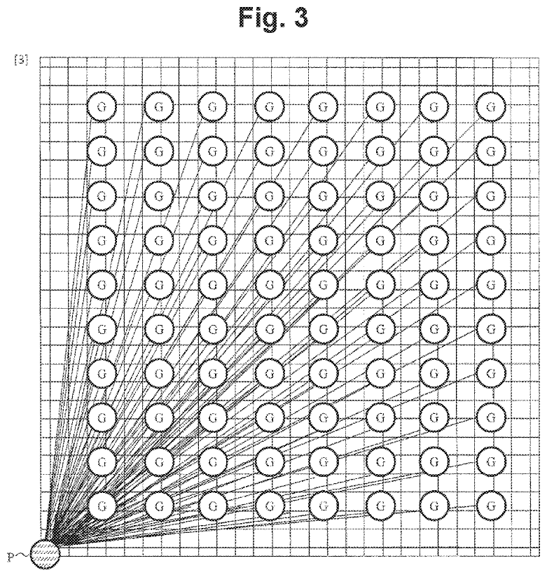

Referring to FIG. 3, description will be made on a case where the cables are single-conductor optical cables, the start point is an aggregation point where the plurality of single-conductor optical cables are aggregated, and the end points are each a location where a rack on which a communication apparatus is to be mounted is installed. In other words, FIG. 3 also illustrates a process for creating a cable routing idea for multi-conductor optical cables to be routed under a double floor (Steps S11 to S12).

First, the entire communication machine room is divided in units of meshes (Step S11) as described with reference to FIG. 2. Next, the necessary number of conductors of the optical cables is set per unit of rack from an ultimate demanded number set by demand forecasting in Step S02 as described with reference to FIG. 2.

In FIG. 3, the racks are not grouped. Accordingly, a plurality of route ideas (cable routing ideas) for routing the single-conductor optical cables for the necessary number of conductors are set within a floor of the communication machine room with the assumption that the aggregation point (either one aggregation point or a plurality of aggregation points are acceptable), at which the optical cables all over the floor are aggregated, is defined as the start point and the racks are defined as the end points (Step S12). The routes are to be selected in accordance with two of the rules, Rules (B) and (C), described with reference to FIG. 2.

Further, the 12 routing patterns in FIG. 4 are also used as routing patterns to be allocated to the meshes in making a cable routing idea.

FIG. 4 is a list of cable installation patterns per unit of mesh. There are two patterns of an “I-pattern”: patterns with cable installation angles of 0° and 90°.

There are four patterns of an “L-pattern”: patterns with cable installation angles of 0°, 90°, 180°, and 270°.
There are four patterns of a “T-pattern”: patterns with cable installation angles of 0°, 90°, 180°, and 270°.
There is one pattern of a “+-pattern”: a pattern with an cable installation angle of 0°.
A “no pattern” means that there is no cable installed in the mesh.

One of the 12 cable installation patterns in FIG. 4 is selected for each of the meshes.

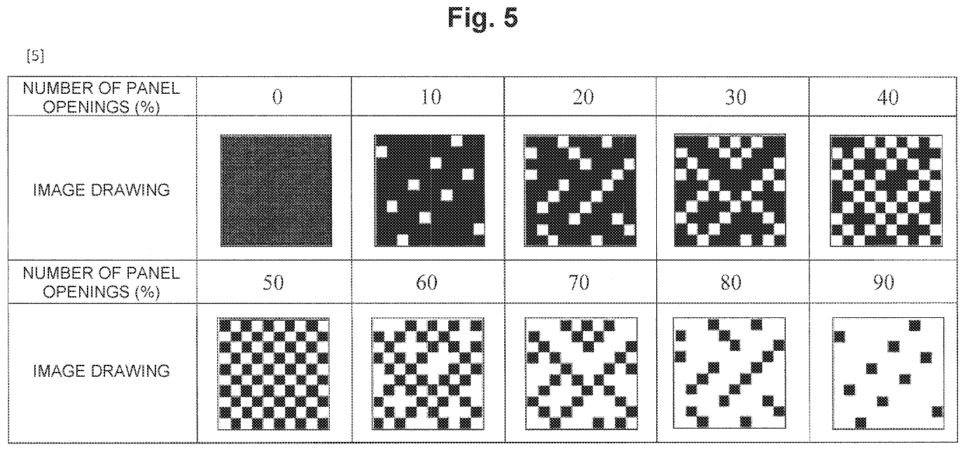

Next, a process for allocating an area ratio of a ventilation opening (a panel opening ratio) to each of the meshes is performed (Step S13). FIG. 5 is a list of panel opening ratios of a double floor panel. A larger numeral of the panel opening ratio means that cool air under a double floor is more likely to flow above the double floor. An opening ratio of 0% means that the panel has no ventilation opening and an opening ratio of 50% means that the panel has a ventilation opening an area of which is the same in ratio as an area of a panel frame. The opening ratio is set in increments of 10%, providing 10 patterns ranging from 0% to 90%. The nearest one of the 10 patterns of the panel opening ratio is selected and set for each of the meshes on the basis of actual equipment information.

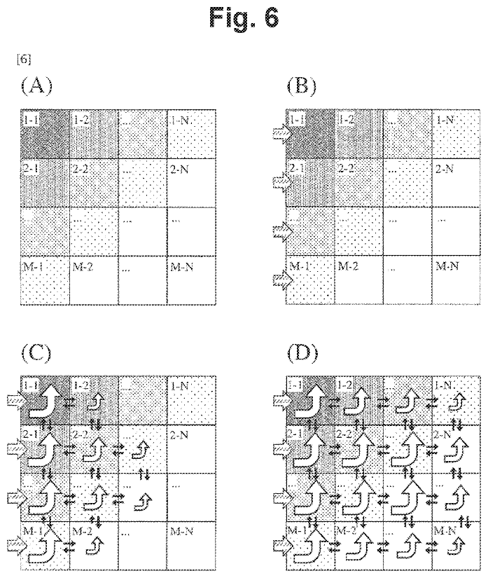

Next, a dimension of an air-conditioning space is calculated and a process for analyzing an airflow is performed (Steps S14 and S15). FIG. 6 illustrates the processes in Steps S14 and S15. The cable installation pattern created in Step S12 and the panel opening ratio allocated in Step S13 are set for each of the meshes (FIG. 6(A)). A cable group volume is then obtained for each of the meshes from a cable type and the number of the cables. Respective cross-sectional areas of cable types are determined according to specifications, so that a total volume of the cables installed in the mesh can be calculated from the number and length of the cables. The total volume is referred to as “cable group volume.”

Subsequently, the dimension of the air-conditioning space under the double floor is calculated. For example, a value given by subtracting the cable group volume from a volume of the space under the double floor for each of the meshes may be defined as the “dimension of the air-conditioning space.” In the present embodiment, a value given by subtracting a height given by dividing the cable group volume by the area of the mesh from a height under the double floor is defined as the “dimension of the air-conditioning space.” Respective heights for air-conditioning of all the meshes are calculated and the heights for air-conditioning in the space under the double floor are heat-mapped.

Next, airflow analysis (Step S15) will be described. An actual installation location of an air conditioner is set in a model of the floor divided into meshes in Step S11. In the model, an airflow with predetermined temperature, flow speed, and flow direction from the air conditioner is then set in the meshes where the air conditioner is set (FIG. 6(B), time T=0). A change in each of the temperature, flow speed, and flow direction of the airflow ejected from the ventilation opening of the double floor is then calculated by thermo-fluid analysis (a finite volume method) (FIG. 6(C), time T=t1). This analysis is repeated until the flow speed of the airflow from the ventilation opening of the double floor decreases to a predetermined level (FIG. 6(D), time T=t2; Step S16).

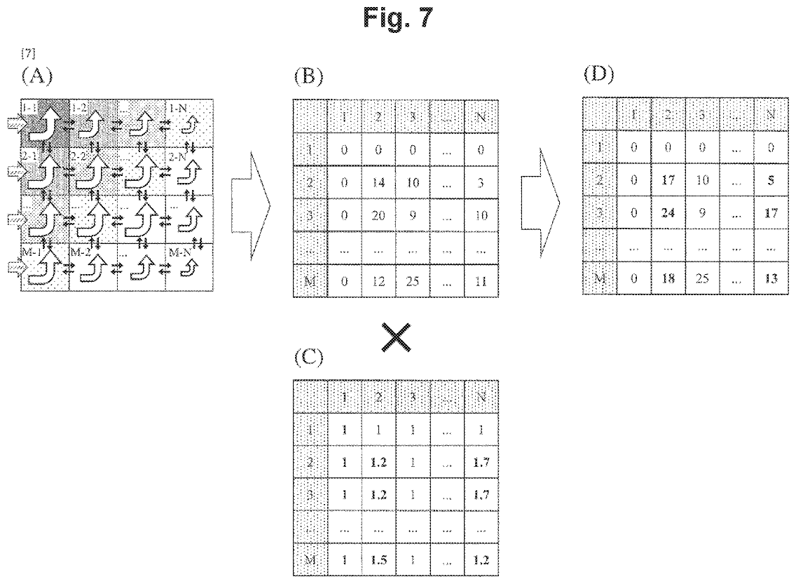

FIG. 7 illustrates a process for evaluating an air-conditioning efficiency in Step S17. FIG. 7(A) illustrates levels of the flow speed of the airflow having decreased to the predetermined level, which is acquired in Step S16, from the ventilation opening of the double floor. FIG. 7(B) is a table of the flow speeds in the form of numerical values. For example, a total of the numerical values in the table in FIG. 7(B) is calculated for each of the cable routing ideas and a cable routing idea with a larger total can be rated higher in terms of air-conditioning efficiency.

Further, in evaluating, a weight coefficient for each of the meshes as in FIG. 7(C) may be taken into consideration. Within the floor of the communication machine room/DC, there are a rack for mounting a high-heat-generating server, a rack for mounting an important user, a rack for mounting both of them, etc. and a level of importance is different with each of the racks. The area ratio of the ventilation opening of the double floor panel, through which air-conditioning for cooling the racks is delivered, is determined as described above. Accordingly, respective weight coefficients are set in the meshes in accordance with the level of importance of each of the racks.

For example, a weight coefficient of 1.0 is set in a mesh corresponding to a rack the level of importance of which is low.

A weight coefficient of 1.2 is set in a mesh corresponding to a rack on a cold-aisle side.

A weight coefficient of 1.5 is set in a mesh corresponding to a high-heat-generating rack on a cold-aisle side.

A weight coefficient of 1.5 is set in a mesh corresponding to a rack for an important user on a cold-aisle side.

A weight coefficient of 1.7 is set in a mesh corresponding to a high-heat-generating rack for an important user on a cold-aisle side.

To sum up, a high weight coefficient is set in a mesh of the panel of the double floor where an airflow is wished to flow out from the ventilation opening.

An air-conditioning value is then calculated for each of the meshes by multiplying the flow speed of the airflow flowing out above the double floor by the weight coefficient (FIG. 7(D)). Likewise, a total of the numerical values in the table in FIG. 7(D) is calculated for each of the cable routing ideas and a cable routing idea with a larger total can be rated higher in terms of air-conditioning efficiency.

[Annex]

Description will be made below on.

According to the present invention, for the purpose of optimizing the air-conditioning efficiency, optical cables are routed such that an air-conditioning space under a double floor becomes as uniform as possible and a floor is modeled in a mesh structure. One of optical cable routing patterns is applied to each of meshes and an air-conditioning airflow is calculated by a finite volume method. It is possible to index an air-conditioning efficiency at that time as a numerical value. It is also possible to propose an optimal routing route by comparison with a case where another route routing is performed. The present invention is also applicable in a case where an amount of the air-conditioning space under the double floor or a panel opening ratio is changed.

A cable route design method according to the present embodiment is as follows.

(1): The present cable route design method is a method of calculating an occupation ratio of multi-conductor optical cables routed under a double floor in a space under the double floor, the method including:
dividing a plan view of a communication machine room in units of meshes;
setting the necessary number of conductors of the optical cables per unit of rack from an ultimate demanded number;
setting a plurality of route ideas for routing the optical cables with the necessary number of conductors within a floor of the communication machine room with the assumption that an aggregation point where the optical cables all over the floor are aggregated is defined as a start point and sub-aggregation points are defined as end points; and
selecting each of the meshes from a plurality of routing patterns for the optical cables.

(2): The present cable route design method is a method of calculating an occupation ratio of multi-conductor optical cables routed under a double floor in a space under the double floor, the method including:

dividing a plan view of a communication machine room in units of meshes;
setting the necessary number of conductors of the optical cables per unit of rack from an ultimate demanded number;
setting a plurality of neighboring racks as one group and setting one sub-aggregation point for the optical cables per unit of group;
obtaining the necessary number of conductors per unit of group of the plurality of racks by integrating the respective necessary numbers of conductors for the racks and setting the obtained necessary number as the necessary number of conductors at the sub-aggregation point;
setting a plurality of route ideas for routing the optical cables with the necessary number of conductors within a floor of the communication machine room with the assumption that an aggregation point where the optical cables all over the floor are aggregated is defined as a start point and the sub-aggregation points are defined as end points; and
selecting each of the meshes from a plurality of routing patterns for the optical cables.

(3): The plurality of routing patterns in the present cable route design method include:

a pattern where the routing form is an I-shape and the possible installation angles are 0° and 90°;
a pattern where the routing form is an L-shape and the possible installation angles are 0°, 90°, 180°, and 270°;
a pattern where the routing form is a T-shape and the possible installation angles are 0°, 90°, 180°, and 270°; and
a pattern where the routing form is a +-shape and the possible installation angle is 0°.

(4): In the present cable route design method, with the assumption that a ratio between an area of a ventilation opening of a double floor panel and an area of a frame of the panel is defined as a panel opening ratio, there are a plurality of panel opening ratios ranging from 0% to 90% in predetermined increments.

(5): The present cable route design method is a method of calculating an air-conditioning efficiency, the method including:

selecting one of a plurality of cable installation patterns for each of meshes;
selecting one of the plurality of panel opening ratios for each of the meshes;
calculating, for each of the meshes, a height of a space for air-conditioning by obtaining a cable group volume from the cable installation pattern and predetermined type and number of cables with use of a related table and subtracting a height of the cable group volume from a height under a double floor included in equipment information;
setting an actual installation location of an air conditioner in a model and heat-mapping a height for air-conditioning in a space under the double floor by thermo-fluid analysis
dividing a floor of an actual communication machine room/DC into meshes; and
causing the air conditioner to deliver cool air with predetermined temperature, flow speed, and flow direction and calculating the temperature, flow speed, and flow direction of cool air delivered from an opening of the double floor panel by a finite volume method, in which in the finite volume method, analysis is repeated until the flow speed of the cool air delivered from the opening of the double floor panel decreases to a predetermined level.

(6): The present cable route design method is a method of evaluating the best air-amount efficiency, the method including:

setting, in proportion to a level of importance of each of racks within a floor of a communication machine room, a level of importance of each of meshes and setting a weight coefficient;
obtaining, for each of the meshes, an air-conditioning value by multiplying a value of air-conditioning flowing out above a double floor obtained by thermo-fluid analysis by the weight coefficient set for each of the meshes;
defining a total of the air-conditioning values of all the meshes obtained by multiplication by the weight coefficients as an air-conditioning value resulting from that routing; and
calculating air-conditioning values resulting from other routings in a similar manner and comparing the air-conditioning values.

### Effects of the Invention

The present algorithm makes it possible to quantify an air-conditioning efficiency for each of optical cable routing configurations, enabling comparison with an air-conditioning efficiency resulting from designing another route. Application of the present algorithm to a routing design method makes it possible to calculate an air-conditioning efficiency in order to derive a routing method enabling optimizing the total cost. This is useful to a data center company in reducing costs.

### REFERENCE SIGNS LIST

11 Calculator

1. A cable route design method of routing, within one floor where there are one or a plurality of start points and a plurality of end points, a plurality of cables connecting respective pairs of the start point and the end points, the cable route design method comprising:
in a case where the floor has a double floor structure and the cables are to be routed in an underfloor space for air-conditioning,
dividing the floor into two-dimensional meshes;
creating a cable routing idea for routing within the floor by allocating one of a plurality of preset cable installation patterns to each of the meshes in accordance with a predetermined rule;
allocating an area ratio of a ventilation opening formed in a floor surface of the floor for each of the meshes to each of the meshes of the cable routing idea;
calculating, for each of the meshes, a value indicating a dimension of a space for air-conditioning based on a volume of the underfloor space and a group volume of the cables;
adding an air-conditioning airflow to a model of the underfloor space in which the meshes are heat-mapped based on the value regarding the space for air-conditioning and performing thermo-fluid analysis of the airflow in the underfloor space until the airflow flowing out of the underfloor space through the ventilation opening decreases to a predetermined level;
acquiring, for each of the meshes, a flow speed of the decreased airflow flowing out of the underfloor space; and
summing the flow speeds in all the meshes as an evaluation value of the cable routing idea, wherein
the predetermined rule comprises:
(1) preventing the cables from intersecting as much as possible and, in a case where the cables inevitably intersect, equalizing a position of one of the meshes where the cables intersect within the floor; and
(2) shortening a total distance of the routed cables as much as possible.

2. The cable route design method according to claim 1, wherein among a plurality of the cable routing ideas, the cable routing idea the evaluation value of which is highest is selected as an optimal idea.

3. The cable route design method according to claim 1, wherein the flow speeds are multiplied by respective weight coefficients for the meshes and the flow speeds multiplied by the respective weight coefficients are summed as the evaluation value.

4. The cable route design method according to claim 1, wherein the value indicating the dimension of the space for air-conditioning is a height of the space for air-conditioning calculated by subtracting the group volume of the cables from the volume of the underfloor space.

5. The cable route design method according to claim 1, wherein
the cables are single-conductor optical cables,
the start point is an aggregation point where the plurality of single-conductor optical cables are aggregated, and
the end points are each a location where a rack on which a communication apparatus is to be mounted is installed.

6. The cable route design method according to claim 1, wherein
the cables are multi-conductor optical cables,
the start point is an aggregation point where the plurality of multi-conductor optical cables are aggregated, and
with an assumption that a plurality of racks on which communication apparatuses are to be mounted are considered as one group, the end points are sub-aggregation points disposed on a one-by-one basis at groups each comprising a plurality of racks on which communication apparatuses are to be mounted.

7. The cable route design method according to claim 6, wherein the number of conductors of the multi-conductor optical cables to be selected is a nearest number of conductors larger than a necessary number of conductors based on future communication demand forecasting.
